(19) United States
(12) Patent Application Publication
(10) Pub. No.: US 2009/0280211 A1
(43) Pub. Date: Nov. 12, 2009

(54) METHOD OF PREPARING A FOOD PRODUCT

(76) Inventors: Robert B. Friedman, Chicago, IL (US); Elena S. Mirzoeva, Cary, IL (US); Dominic D. Lettiere, Oak Lawn, IL (US); Armando J. Castro, Westchester, IL (US)

Correspondence Address: WRIGLEY & DREYFUS 28455;BRINKS HOFER GILSON & LIONE, P.O. BOX 10395, CHICAGO, IL, 60610, US

(21) Appl. No.: 12/264,035

(22) Filed: Nov. 3, 2008

Related U.S. Application Data
(63) Continuation-in-part of application No. PCT/US07/11253, filed on May 9, 2007.
(60) Provisional application No. 60/801,164, filed on May 17, 2006.

(51) Int. Cl. A23G 4/06; A23L 1/236; A23P 1/02; A23G 4/18

(52) U.S. Cl. 426/3; 426/285

(57) ABSTRACT

A method of preparing a food product includes providing a high-intensity sweetener selected from the group consisting of acesulfame-K, sucralose, glycyrrhizinate, dihydrochalcones, monellin, inonatin and mixtures thereof. A binder selected from the group consisting of aluminosilicates, polyvinyl acetate, polyols, silica, monioglycerides, waxes and mixtures thereof is provided. The binder and the high-intensity sweetener are compacted in a roll compactor to form a compacted mixture. The compacted mixture is added to a food product. In one embodiment, a chewing gum composition includes gum base; bulk sweetener; flavor and the compacted mixture.

### REFERENCE TO EARLIER FILED APPLICATIONS

The present application is a continuation-in-part, and claims the benefit of the filing date under 35 U.S.C. § 120, of PCT Patent Application Serial No. PCT/US07/011253, filed May 9, 2007; and also claims the benefit of the filing date under 35 U.S.C. § 119(e) of Provisional U.S. Patent Application Ser. No. 60/801,164, filed May 17, 2006; both of which are hereby incorporated by reference in their entirety.

### BACKGROUND

The present invention relates to a method of incorporating an additive, particularly a sweetener or a flavoring agent, into a food product. In particular, it relates to a method of incorporating a high-intensity sweetener into a chewing gum product.

It is desirable for certain food products, such as chewing gums, to have a sustained release of sweetener or flavor while the product is chewed. It is desirable that all the sweetener or flavor not be released in a short time after beginning chewing, but that the product provide a high level of sweetness and flavor for a long period, such as 10 to 20 minutes or more. To develop this extended release profile, high-intensity sweeteners or other flavoring agents may be incorporated into a matrix that dissolves slowly through the chewing process. A commonly used method involves a wet granulation process. In wet granulation, the sweetener is mixed with a binder in solution or suspension form and the resulting mixture is dried. However, wet granulation requires substantial equipment, and high energy levels, particularly to run a mixer, a fluid bed dryer or a static dryer. Additionally, some materials, such as acesulfame-K and sucralose, cannot be compounded by wet granulation because they either dissolve too rapidly in water or deteriorate during the drying process. Other processes for incorporating a sweetener in a binder have used an extrusion technique. However, extrusion involves high temperature and high shear rates, which can degrade many sweeteners.

### BRIEF SUMMARY

It has been found that by dry granulation, such as roll compaction, an additive such as a sweetener or flavoring agent can be combined with a binding agent and used to form a food product that provides a sustained release of the additive when the food product is used by a consumer.

In one aspect, a method of preparing a food product includes providing a high-intenisity sweetener selected from the group consisting of acesulfame-K, sucralose, and mixtures thereof. A binder and the high-intensity sweetener are compacted in a roll compactor to form a compacted mixture. The compacted mixture is added to a food product.

In another aspect, a method of preparing a chewing gum product includes providing a high-intensity sweetener. A binder selected from the group consisting of aluminlosilicates, polyvinyl acetate, polyols, silica, monoglycerides, waxes and mixtures thereof is provided. The binder and the high-intensity sweetener are compacted in a roll compactor to form a compacted mixture. The compacted mixture is mixed with gum base to form a chewing gum composition. The chewing gum composition is formed into a chewing gum product.

The foregoing and other features and advantages of the present invention will become apparent from the following detailed description of the presently preferred embodiments, when read in conjunction with the accompanying examples.

### BRIEF DESCRIPTION OF THE DRAWINGS

FIG. 1 is a schematic drawing of one embodiment of a roll compaction process.

FIG. 2 is a graph showing the sweetness release as a function of time for several embodiments of compacted sweeteners in chewing gum.

### DETAILED DESCRIPTION OF THE PREFERRED EMBODIMENTS

The present invention will now be further described. In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

The present invention is directed to methods of compacting an additive, such as high-intensity sweetener and/or a flavoring agent. To develop an extended release profile for the sweetener or flavoring agent, the additive is compounded into a mixture that dissolves slowly through the chewing process. It has been found that by compacting the additive and a binder, a compacted mixture is formed that provides an acceptable sustained release profile. To compound the additive and the binder, they are first mixed together. The mixed additive and binder are compacted together in a roll compactor to produce a compacted mixture or blend. The compacted mixture may be ground to a desired particle size and/or further treated prior to being added to the food product. The compacted mixture may then be added to a food product, such as a chewing gum, to provide a sustained release of the additive.

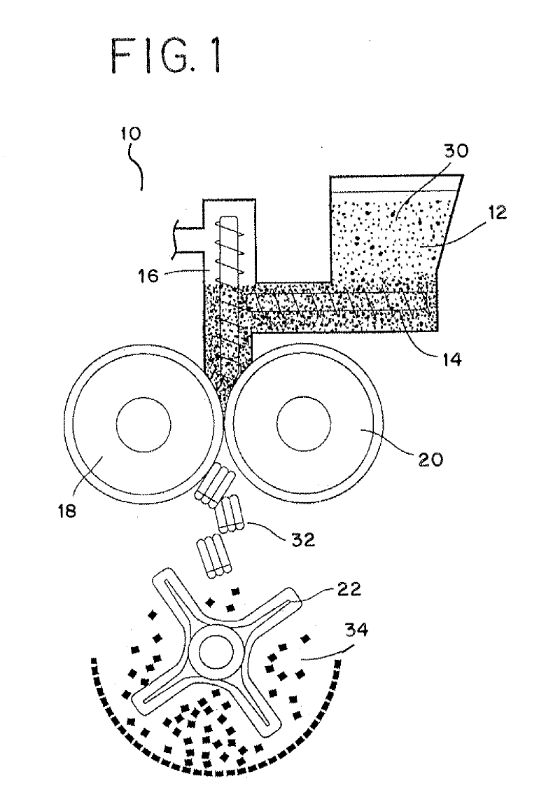

A schematic of one embodiment of a roll compaction process is shown in FIG. 1. Feed material 30, including one or more additives and binder, is delivered to the upper feed hopper 12 of the compactor 10. A horizontal feed screw 14 meters the product from the feed hopper into the pre-compression stage. Pre-compression (and optional deaeration) is carried in a vertical feed screw 16, which normally operates at a speed significantly higher than the metering screw. Deaeration can reduce the quantity of uncompacted material and increase throughput. The vertical screw 16 may rotate at about 250 rpm, and the horizontal screw 14 at a rate of about 30 rpm. The vertical screw 16 forces the material to the rolls 18, 20 where the compaction takes place. Other orientations of the screws and rolls are possible. Suitable roll compactors are available from Fitzpatrick Co. and Vector Corp.

The main compaction of the product occurs between two counter rotating rolls 18, 20 which act under pressure provided by a hydraulic cylinder (not shown), the force of which is applied to one floating roll. The basic concept of roll compaction is that as the volume decreases through the region of maximum pressure, the material is compacted together. Some factors controlling the compaction process include the roll surface, roil diameter, roll speed, roll pressure, feed screw speed and design, and material properties. The operating pressure between the rolls is typically between 5,000 and 40,000 psi, preferably between 10,000 and 22,000 psi. The temperature of the mixture is preferably maintained at less than about 50° C. during roll compaction. The gap between the rolls is typically between about 0.01 and about 0.05 inches, preferably between about 0.016 and about 0.024 inches. The roll speed is typically about 5 rpm.

The surface of the roll can be a variety of configurations to control the shape of the compacted mixture. For example, smooth rolls can form sheets while indented rolls can form pillows or bars. In one embodiment, rolls with sinusoidal surfaces are used to minimize the chances of binding on the rolls. The rolls with sinusoidal surfaces produce ribbons of compacted material. Elastic recovery of compacted material occurs after it is released from the rolls. After the additive is compacted with the binder, the compacted mixture may then be sized in order to provide a particular sized compound. The compacted material may be gravity-fed to a granulation device 22 to break up the compacted material 32 into smaller pieces 34. In one embodiment, a FitzMill Comminutor is used.

Direct roll compaction and other methods of dry granulation may include several advantages over a wet granulation technique. Roll compaction does not require wetting and drying steps, and agglomeration occurs at room temperature and low shear. Thus there is a savings in energy and production time. Process variables such as roll pressure, roll spacing, and rotation speed, are adjustable and allow for processing of the variety of materials with large differences in compaction properties.

After roll compaction, the compacted mixture may be further encapsulated with a binder, overcoating, or other material before adding it to the food product. Encapsulation techniques include but are not limited to fluidized bed coating, extrusion, and spray drying. The compaction and encapsulation techniques may be used to provide a food product providing a sustained release, delayed release, or multiple waves of flavor and/or sweetener.

Food products used with the compacted mixture include any sort of product a user would put in the mouth, including confections such as candy and chewing gum. The compacted mixture may also be used in other types of candy products. It is particularly preferred for use in a compressed mint, compressed chewing gum, or chewy confectionery product. Examples of chewy confections include jellies, gummies, caramels, nougats, and taffies.

The additive used in the roll compaction process may be a sweetener, flavoring agent, other additives, or combinations thereof.

High-intenisity sweeteners which may be used in the compacting process include, but are not limited to, sucralose, aspartame, N-substituted APM derivatives such as neotame, acesulfame acid or its salts, alitame, saccharin and its salts, cyclamic acid and its salts, glycyrrhizinate, dihydrochalcones, thaumatin, monellin, monatin; and aminoacid-, dipeptide-, peptide-, and protein-based sweeteners, and the like, alone or in combination. In one embodiment, the high-intensity sweetener may be selected from acesulfame-K (acesulfame potassium), glycyrrhizinate, dihydrochalcones, monellin, monatin and sucralose. The compacting process is particularly useful for acesulfame-K.

The term “flavoring agent” is meant to include flavors, cooling agents, sensates, and the like. The flavoring agents may comprise essential oils, synthetic flavors, or mixtures thereof including, but not limited to oils derived from plants and fruits such as citrus oils, fruit essences, peppermint oil, spearmint oil, clove oil, oil of wintergreen, anise, and the like. Artificial flavoring components are also contemplated for use in the food products of the present invention. Dry flavors such as menthol or dried flavor blends of oils or fruit essences are contemplated for the present invention. Liquid flavors may be blended with the sweetener prior to roll compaction. Those skilled in the art will recognize that natural and artificial flavoring agents may be combined in any sensorally acceptable blend. All such flavors and flavor blends are contemplated by the present invention.

Physiological cooling agents may also be used. Physiological cooling agents include, but are not limited to substituted p-menthane carboxamides (such as WS-3); acyclic carboxamides (such as WS-23); menthone glycerol ketal; menthyl lactate; menthyl succinate; and 3-1-menthoxypropane-1,2-diol.

Sensates may also be used as flavoring agents and include cooling agents, pungent, hot, salivation enhancers and tingling flavors.

Optional ingredients such as colors, emulsifiers and pharmaceutical agents may be added to the chewing gum or other food product.

The binder may be any suitable binder for providing a compacted composition with a high-intensity sweetener or flavoring agent. The binder may be milled before use to provide a desired particle size. Binders that may be used include, but are not limited to, cellulosic polymers, aluminosilicates, polysaccharides, Zein, silica, monoglycerides, proteins, waxes, gum arabic, polyols, other polymers such as polyvinyl acetate, and mixtures thereof. Cellulosic polymers and their derivatives (including neutral and charged polymers) include carboxymethylcellulose (CMC), sodium carboxymethylcellulose (sodium CMC), hydroxypropylmethylcellulose (HPMC), hydroxypropylmethylcellulose (HPC), and cellulose gel. Cellulosic polymers are available from Hercules and Dow. Saccharides, oligosaccharides and polysaccharides include modified starch, cyclodextrin, pectin, beta-glucan, corn syrup solids, maltodextrins, sugars, and sodium gluconate. Polyols include sorbitol, erythritol, mannitol, maltitol, lactitol, isomalt, hydrogenated isomaltulose, and hydrogenated starch hydrolyzates. Various polyols are available from Roquette and Cargill. Suitable aluminosilicates include montmorillonites, which are high purity aluminosilicate minerals or clay materials (also known as phyllosilicates). This category includes nanoclay, available form Nanocor. In one embodiment, the binder may be selected from aluminosilicates, polyvinyl acetate, polyols, silica, monoglycerides, waxes and mixtures thereof.

The sweetener and binder are generally provided in various powder forms to produce the desired product characteristics. The amount of binder used to form the compacted mixture is selected to produce the desired characteristics. The amount of binder in the compacted mixture typically varies between about 1% and about 50% by weight, between about 1% and about 25%, by weight, or between 5% and about 20% by weight. The binder may be about 15% by weight.

It is desirable in many food products, such as confections including candy and chewing gum, for a sweetener to have an extended sweetness release profile. Thus, the binder should form a compacted mixture that delays the release of the sweetener when the compacted mixture is incorporated into a product. While not intending to be bound by theory, it is believed that good compaction of the binder and the sweetener may control diffusion rate, and may be attributed to specific chemical properties (such as intermolecular arrangements), physical properties (such as surface charges) and/or morphological properties of the binders.

In the case of aluminosilicates such as nanoclay, good compaction may be attributed to a unique multi-layered structure, where surface and edge charges are balanced with counter-ions from the inner layers. Such a structure allows for sweetener particles to easily penetrate in between these nano-sheets and form a homogeneous stable blend which compacts well and results in dense and durable agglomerates.

In the case of macromolecular materials such as celluloses, PVAc, starch, and proteins, compaction properties may be defined by intermolecular interactions, nature and location of the ionic groups. For example, macromolecules of polymeric binders (such as celluloses, starches, polyvinyl acetate, and Zein) may be ‘folded’ into large multilayer clusters of lamellar type with low surface energy. It is possible that such supermolecular organization of polymeric binders provides sufficient amount of ionic charges on particle surfaces which results in improved interfacial adhesion and helps to hold agglomerated granules together more efficiently.

In the case of beta-cyclodextrin, it is believed that compaction is typically realized through the ‘inclusion’ mechanism, where the cyclodextrin molecule accepts and holds a molecule of the additive, such as a sweetener molecule, in its hydrophobic cavity while the hydrophilic exterior interacts with other materials. The match between ‘host’ and ‘guest’ molecule dimensions is a factor for successful agglomeration with beta-cyclodextrin.

The compacted mixture, either “as is” or sized to a particular particle size range, and by itself or further encapsulated, is mixed with a food product base to form a food product. In one embodiment, the food product is chewing gum. The compacted mixture is then mixed with gum base to form a chewing gum composition. The level of high-intensity sweetener in the chewing gum should be between about 0.05% and about 5%, preferably between about 0.1% and about 2%. A flavoring agent may be present in the chewing gum in an amount within the range of from about 0.1% to about 10%, preferably from about 0.5% to about 3%, by weight of the gum. The chewing gum composition is then formed into a chewing gum product.

In general, a chewing gum composition typically comprises a water-soluble bulk portion, a water-insoluble chewable gum base portion and typically water-insoluble flavoring agents. The water-soluble portion dissipates with a portion of the flavoring agent over a period of time during chewing. The gum base portion is retained in the mouth throughout the chew.

The insoluble gum base generally comprises elastomers, resins, fats and oils, waxes, softeners and inorganic fillers. Elastomers may include polyisobutylene, isobutylene-isoprene copolymer and styrene butadiene rubber, as well as natural latexes such as chicle. Resins include polyvinyl acetate and terpene resins, Fats and oils may also be included in the gum base, including tallow, hydrogenated and partially hydrogenated vegetable oils, and cocoa butter. Commonly employed waxes include paraffin, microcrystalline and natural waxes such as beeswax and carnauba. The insoluble gum base may constitute between about 5% and about 95% by weight of the gum. More preferably the insoluble gum base comprises between about 10% and about 50% by weight of the gum, and most preferably between about 20% and about 35% by weight of the gum.

The gum base typically also includes a filler component. The filler component may be calcium carbonate, magnesium carbonate, talc, dicalcium phosphate or the like. The filler may constitute between about 54% and about 60% by weight of the gum base. Preferably, the filler comprises about 5% to about 50% by weight of the gum base.

Gum bases typically also contain softeners, including glycerol monostearate and glycerol triacetate. Further, gum bases may also contain optional ingredients such as antioxidants, colors, and emulsifiers. The present invention contemplates employing any commercially acceptable gum base.

The water-soluble portion of the chewing gum may further comprise softeners, sweeteners, flavoring agents and combinations thereof. Softeners are added to the chewing gum in order to optimize the chewability and mouth feel of the gum. Softeners, also known in the art as plasticizers or plasticizing agents, generally constitute between about 0.5% and about 15% by weight of the chewing gum. Softeners include glycerin, lecithin and combinations thereof. Further, aqueous sweetener solutions such as those containing sorbitol, hydrogenated starch hydrolyzates, corn syrup and combinations thereof may be used as softeners and binding agents in gum.

The chewing gum product may include other sweeteners in addition to those provided in the compounded mixture. Sugarless sweeteners include components with sweetening characteristics but which are devoid of the commonly known sugars and comprise, but are not limited to, sugar alcohols such as sorbitol, mannitol, xylitol, hydrogenated starch hydrolyzates, maltitol and the like, alone or in any combination.

Sugar bulk sweeteners include, but are not limited to, sucrose, dextrose, maltose, dextrin, dried invert sugar, fructose, levulose, galactose, corn syrup solids, and the like, alone or in combination.

In general, chewing gum is manufactured by sequentially adding the various chewing gum ingredients to a commercially available mixer known in the art. After the ingredients have been thoroughly mixed, the gum mass is discharged from the mixer and shaped into the desired form such as by rolling into sheets and cutting into sticks, extruding into chunks or casting into pellets. A pellet center may be coated with a hard shell coating that may also contain flavoring agents to give a fast release of flavor initially.

Generally, the ingredients are nixed by first melting the gum base and adding it to the running mixer. The base may also be melted in the mixer itself. Color or emulsifiers may also be added at this time. A softener such as glycerin may also be added at this time, along with syrup and a portion of the bulking agent. Further portions of the bulking agent may then be added to the mixer. A flavoring agent is typically added with the final portion of the bulking agent. The coated flavoring agent of the present invention is preferably added after the final portion of bulking agent and flavor have been added.

The entire mixing procedure typically takes from five to fifteen minutes, but longer mixing times may sometimes be required. Those skilled in the art will recognize that many variations of the above described procedure may be followed.

### EXAMPLES

The following examples of the invention and comparative examples are provided by way of explanation and illustration.

### Roll Compaction

A roll compactor was used to compact selected high-intensity sweeteners and binders. A model IR220/Chilsonator scale roll compactor from Fitzpatrick was used for Examples 1-19, and a Vector roll compactor was used for Examples 20-24. The mixtures of sweeteners and binders, pre-blended with a V-blender, were added to a hopper and were then conveyed to the rolls by positive pressure single screw conveyers. All screening tests were performed at constant roll rotation value 5 rpm to keep low shear. Roll force was maintained at less than 21,000 psi. The temperature of compressed product did not exceed 41.3° C. The roll gap was adjusted within a range of 0.016-0.024 inches. The ability of the materials to physically compress and hold a ribbon-like shape after being discharged from the roll compactor was evaluated visually and ranked. The results are shown below in Table 1.

TABLE 1

| Example No. | Sweetener | Binder | Agglomeration |
|---|---|---|---|
| 1 | aspartame | HPC (Klucel) | fair |
| 2 | aspartame | HPMC (Methocel) | fair |
| 3 | acesulfame-K | HPC (Klucel) | fair |
| 4 | acesulfame-K | HPMC (Methocel) | good |
| 5 | acesulfame-K | HPMC (K-99) | good |
| 6 | acesulfame-K | HPMC (K-250) | fair |
| 7 | acesulfame-K | CMC | fair |
| 8 | acesulfame-K | Sodium CMC | good |
| 9 | acesulfame-K | cellulose gel | good |
| 10 | acesulfame-K | starch (OSAN) | good |
| 11 | acesulfame-K | cyclodextrin | good |
| 12 | acesulfame-K | pectin | fair |
| 13 | acesulfame-K | beta-glucan | fair |
| 14 | acesulfame-K | sodium gluconate | fair |
| 15 | aspartame | sorbitol | good |
| 16 | acesulfame-K | sorbitol | fair |
| 17 | acesulfame-K | polyvinyl acetate | good |
| 18 | acesulfame-K | nanoclay | excellent |
| 19 | acesulfame-K | Zein | fair |
| 20 | acesulfame-K | HPMC (K-250) | good |
| 21 | acesulfame-K | HPMC (Methocel E4) | good |
| 22 | aspartame | HPMC (Methocel E4) | excellent |
| 23 | acesulfame-K | Sodium CMC | fair |
| 24 | sucralose | HPMC (Methocel E4) | good |

After roll compaction, size reduction for compacted materials was performed with RoTap lab sieve shaker equipped with a series of five screens and a pan. The screens were sized between 20 and 325 screen size. The material retained on screen size No. 40 was collected to produce chewing gum products.

The compacted high-intensity sweeteners listed in Table 1 were tested in a sugarless mint gum formula containing 1.06% compacted sweetener, as shown below in Table 2.

TABLE 2
Chewing Gum Formulation

| Ingredient | % |
|---|---|
| Sorbitol | 35.72 |
| Gum base | 19.65 |
| Compacted | 1.06 |
| sweetener | |
| Sugarless syrup* | 41.0 |
| Peppermint flavor | 0.9 |
| Glycerin | 1.42 |
| Lecithin | 0.25 |
| Total | 100 |

*the sugarless syrup contained approximately 51% sorbitol, 5.5% maltitol, 1.5% mannitol, 39% glycerin, and 3% water

Chewing gum was produced according to the procedure described above. A control sample (Comparative Example A) was prepared using a sweetener mixture prepared by wet granulating aspartame with HPMC, in place of the compacted sweetener. Gum samples were aged for two weeks at ambient conditions and evaluated by internal bench sensory panel.

### Sweetness Release

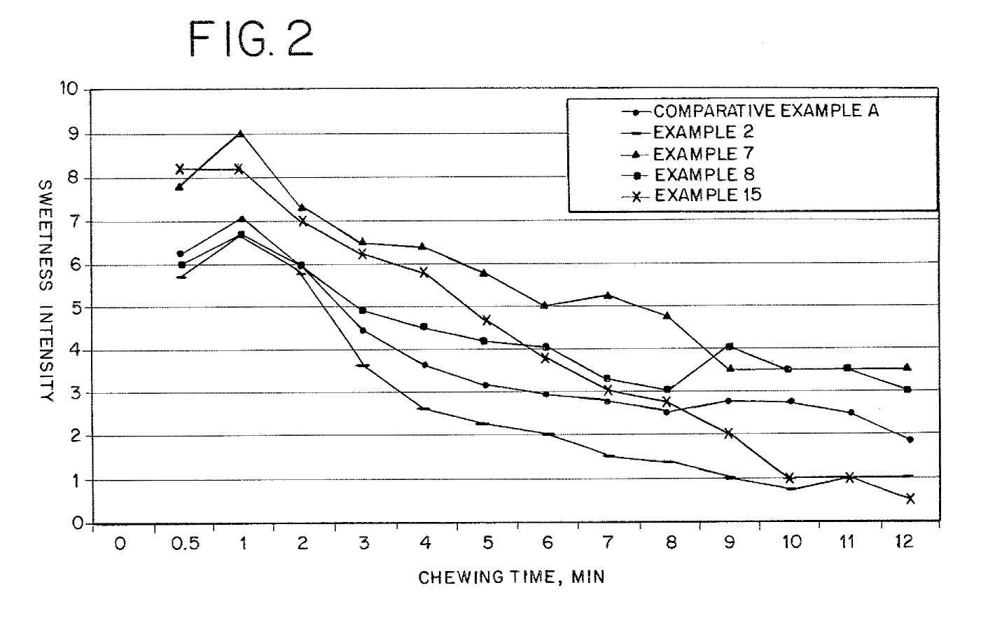

Descriptive chew out tests were performed to assess sweetness characteristics of experimental samples. Analytical testing was performed to determine the residual levels of sweetener in gum cuds. Sweetness release profiles were compiled from chewing gums using the compounded mixtures of Examples 1-19. The chewing gums gave varied sweetness profiles and demonstrated acceptable sweetness duration and intensity. FIG. 2 is a graph showing the sweetness release as a function of time for representative chewing gums incorporating the compacted mixtures of Examples 2, 7, 8, and 15, and Comparative Example A. It can be seen that the chewing gums demonstrated acceptable sweetness duration and intensity over a 12 minute period of chewing time.

It should be appreciated that the methods and compositions of the present invention are capable of being incorporated in the form of a variety of embodiments, only a few of which have been illustrated and described above. The invention may be embodied in other forms without departing from its spirit or essential characteristics. It will be appreciated that the addition of some other ingredients, process steps, materials or components not specifically included will have an adverse impact on the present invention. The best mode of the invention may therefore exclude ingredients, process steps, materials or components other than those listed above for inclusion or use in the invention. However, the described embodiments are to be considered in all respects only as illustrative and not restrictive, and the scope of the invention is, therefore, indicated by the appended claims rather than by the foregoing description. All changes which come within the meaning and range of equivalency of the claims are to be embraced within their scope.

What is claimed is:

1. A method of preparing a food product comprising:
a) providing a high-intensity sweetener selected from the group consisting of acesulfame-K, sucralose and mixtures thereof
b) providing a binder selected from the group consisting of polyvinyl acetate, silica, monoglycerides, waxes, aluminosilicates and mixtures thereof;
c) compacting the binder and the high-intensity sweetener in a roll compactor to form a compacted mixture; and
d) adding the compacted mixture to a food product

2. The method of claim 1 further comprising encapsulating the compacted mixture before adding it to the food product.

3. The method of claim 1 wherein the compacted mixture is between about 1% and about 25% binder by weight.

4. The method of claim 1 wherein the high-intensity sweetener comprises acesulfame-K.

5. The method of claim 1 wherein the temperature of the compacted mixture is maintained at less than about 50° C. during the compaction process.

6. The method of claim 1 wherein the roll compactor comprises two counter-rotating rolls and the pressure between the rolls is less than about 21,000 psi.

7. The method of claim 1 wherein the roll compactor comprises two rolls with sinusoidal surfaces.

8. The method of claim 1 wherein the roll compactor comprises two counter-rotating rolls and the gap between the rolls is between about 0.01 and about 0.05 inches.

9. A method of preparing a chewing gum product comprising:
a) providing a high-intensity sweetener selected from the group consisting of acesulfame-K, sucralose, glycyrrhizinate, dihydrochalcones, monellin, monatin and mixtures thereof;
b) providing a binder selected from the group consisting of aluminosilicates, polyvinyl acetate, polyols, silica, monoglycerides, waxes and mixtures thereof;
c) compacting the binder and the high-intensity sweetener in a roll compactor to form a compacted mixture;
d) mixing the compacted mixture with gum base to form a chewing gum composition; and
e) forming the chewing gum composition into a chewing gum product.

10. The method of claim 9 further comprising encapsulating the compacted mixture before mixing it with the gum base.

11. The method of claim 9 wherein the high-intensity sweetener is selected from the group consisting of acesulfame-K, sucralose and mixtures thereof.

12. The method of claim 11 wherein a sufficient amount of the compacted mixture is added to the chewing gum to provide a level of high-intensity sweetener between about 0.1% to about 2% by weight in the chewing gum product.

13. The method of claim 11 wherein the high-intensity sweetener comprises acesulfame-K.

14. The method of claim 9 wherein the binder is selected from the group consisting of aluminosilicates, polyvinyl acetate and mixtures thereof.

15. The method of claim 9 wherein the binder comprises an aluminosilicate.

16. The method of claim 9 wherein the compacted mixture is sized before being mixed with the gum base to form the chewing gum composition.

17. A chewing gum composition comprising:
a) gum base;
b) bulk sweetener;
c) flavor; and
d) a compacted mixture comprising i) a high-intensity sweetener selected from the group consisting of acesulfame-K, sucralose, glycyrrhizinate, dihydrochalcones, monellin, monatin and mixtures thereof; and ii) a binder selected from the group consisting of aluminosilicates, polyvinyl acetate, polyols, silica, monioglycerides, waxes and mixtures thereof.

18. The chewing gum composition of claim 17 wherein the high-intensity sweetener is selected from the group consisting of acesulfame-K, sucralose and mixtures thereof.

19. The chewing gum composition of claim 17 wherein a sufficient amount of the compacted mixture is added to the chewing gum to provide a level of high-intensity sweetener between about 0.1% to about 2% by weight in the chewing gum product.

20. The chewing gum composition of claim 17 wherein the binder is selected from the group consisting of aluminosilicates, polyvinyl acetate and mixtures thereof.
